(19) United States
(12) Patent Application Publication
(10) Pub. No.: US 2021/0321651 A1
(43) Pub. Date: Oct. 21, 2021

(54) DUSTING-FLOUR MIX

(71) Applicant: NIPPON FLOUR MILLS CO., LTD, Tokyo (JP)

(72) Inventors: Keiji MAKI, Santa Fe Springs, CA (US); Shuma KONDA, Atsugi-shi (JP)

(73) Assignee: NIPPON FLOUR MILLS CO., LTD, Tokyo (JP)

(21) Appl. No.: 16/334,664

(22) PCT Filed: Jan. 12, 2017
(86) PCT No.: PCT/JP2017/000824

§ 371 Date: Mar. 19, 2019

(30) Foreign Application Priority Data
Oct. 24, 2016 (JP) 2016-207814

(51) Int. Cl. A23L 7/157

(52) U.S. Cl. CPC A23L 7/157

(57) ABSTRACT

An object is to provide a dusting flour mix used for deep-fried food, in which the dusting flour mix can suppress generation of lumps without scattering of dusting flour when the dusting flour is coated on a cooking ingredient. The above object is achieved by a dusting flour mix comprising: 14 to 99.9% by mass of a pregelatinized starch and/or a pregelatinized cereal flour; and 0.1 to 86% by mass of an anti-scattering agent, wherein the anti-scattering agent is wheat flour with a content of 0 to 86% by mass and/or an oil and/or fat with a content of 0 to 2.8% by mass relative to the dusting flour mix.

### TECHNICAL FIELD

The present invention relates to a dusting flour mix and a method of producing the same, and in particular to a dusting flour mix which is capable of suppressing generation of lumps and scattering, and a production method thereof.

### BACKGROUND ART

Deep-fried food such as karaage, deep fries, tempura, and fritters is obtained when the cooking ingredient is coated evenly with dusting flour, covered with a breader or batter, attached with seasonings and batter ingredients such as bread crumbs as necessary, and then deep fried.

When used for deep-fried food, dusting flour has functions of maintaining the quality of the cooking ingredient which prevents burning during deep frying and seepage of meat juices, umami taste ingredients, moisture, and the like, a function of suppressing batter separation which binds the cooking ingredient and the batter ingredient, and a function of maintaining the crispy texture of the fried batter by preventing the seepage of moisture in the cooking ingredient to the batter ingredient during preservation after deep frying. Particularly for cooking ingredients with a high water content such as fish and shellfish, meats, and patties for e.g. korokke (croquette), it is common practice to use dusting flour to keep its moisture in the cooking ingredients.

Dusting flour is composed of, as a main raw material, flours such as wheat flour and corn flour, starches such as potato starch and corn starch, powdered proteins such as powdered soybean protein, and the like, and mixtures thereof. When a cooking ingredient is coated with dusting flour, the moisture of the cooking ingredient seeps slightly, and seeped moisture is a cause of the formation of lumps of dusting flour. The lumps of dusting flour increase and grow depending on the quantity of the cooking ingredient handled and the frequency of sprinkling. Along with this, uneven coating of dusting flour on the cooking ingredient occurs, which markedly deteriorates the quality of deep-fried food finally obtained. It is possible to reuse the dusting flour by removing lumps with a sieve or the like and adding unused dusting flour or the like. However, since the moisture which seeped from the cooking ingredient is remaining in the dusting flour passed through the sieve, its performance cannot be fully recovered. For this reason, there has been a demand for dusting flour which is unlikely to produce lumps.

Dusting flour with starch as the main ingredient is likely to cause scattering when the cooking ingredient is coated with the dusting flour because of its small particle size, which may cause contamination of kitchens of households and restaurants and of food factories and also may lead to the loss of the dusting flour. Potato starch with a large starch particle size is often used, but it cannot sufficiently prevent scattering. Therefore, there has been a demand for dusting flour which is unlikely to cause scattering.

Patent Literature 1 discloses a deep fry powdering composition including an age processed starch and/or a pregelatinized starch fine powder. It is described that the characteristics required for a powdering composition are that a physical property is smooth, a hygroscopic property is not present, and particles are not so fine meaning that they do not cause scattering during powdering. However, it is only described that the device suitability of the powder and oil splatter during deep frying were evaluated. No description is provided concerning the suppression of lump formation and scattering. Moreover, scattering is not avoided as shown in the comparative examples of the present invention.

Patent Literature 2 discloses a method of producing a microwave-ready deep fry, including the steps of applying edible oil to the surface of the deep frying food ingredient at normal temperature and sprinkling the surface of the oil-coated food ingredient with gelatinized wheat flour as dusting flour. The object of this invention is to suppress the deterioration of the batter texture (crispy texture) due to the water of the food ingredient at the time of microwave heating after freeze storage for a long period of time, and it is a technique in which an oil layer is formed on the surface of the food ingredient to prevent migration of the free water of the food ingredient to the outside and the free water passed through the oil layer is absorbed by the pregelatinized wheat flour to prevent migration of the free water of the food ingredient to the coating of batter. However, no suggestion is provided on the suppression of lump generation and scattering during coating of dusting flour.

Patent Literature 3 discloses a method of producing a microwave-cooking deep fry, in which the surface of a food ingredient is coated with a water-soluble polymer (at least one selected from hemicelluloses, gums, polysaccharides produced by microorganisms, pregelatinized starches, and partial decomposition products thereof) and then coated with batter liquid, which is deep fried and frozen or refrigerated. This is an invention aiming at suppressing the deterioration of crispy texture of the fried batter and keeping the juicy feeling of the food ingredient even after a passage of time following cooking with a microwave oven, and no description is provided on the combination of pregelatinized starches, oils, and/or wheat flour or on the suppression of lump generation and scattering of dusting flour.

Patent Literature 4 describes spreading of dusting flour of pregelatinized starch on a food ingredient before covering with batter in Examples 5 and 6. This invention relates to a novel starch which is excellent in water absorbability increase during heating (temperature rise) and which is suitably usable for a cooking batter ingredient, particularly for deep fry batter, and no description is provided on the combination of pregelatinized starches, oils, and/or wheat flour or on the suppression of lump production and scattering of dusting flour.

Patent Literature 5 discloses a dusting flour having a composition of 55 to 85% by mass of starch and 15 to 45% by mass of one or both of pregelatinized starch and dry starch with less than 10% by mass of water. The object of this invention is to prepare raw material squid for karaage which prevents dripping during preservation and which does not cause oil spatter in the case of karaage. The object is achieved by kneading a seasoning and common salt having a specific water content or less and a specific particle size or less and lowering the water content of starch used for dusting flour. Therefore, the dusting flour is not necessary to be a pregelatinized starch essentially although pregelatinized starch is in the configuration requirements for the dusting flour, and it is important to use starch with a low water content. Furthermore, no description is provided on the combination of pregelatinized starches, oils, and/or wheat flour or on the suppression of lump production and scattering of dusting flour.

Patent Literature 6 discloses a method of producing food for non-deep fried tatsuta attached with a “batter ingredient formed by blending 1 to 2 parts by weight of an oil and/or fat to 10 parts by weight of dusting flour containing starch and 20 to 60% by mass of rice flour.” The purpose of blending an oil and/or fat to batting is to attach dusting flour to the food ingredient and to impart powdery and crispy texture by suppressing the influence of water on starch during steaming step for suppression of gelatinization. It is not suggested that addition of an oil and/or fat to dusting flour can suppress scattering.

As described above, no disclosure is provided on a technique of suppressing the generation of lumps and scattering when sprinkling the food ingredient with dusting flour, and there has been a demand for a dusting flour which suppresses them.

### CITATION LIST

### Patent Literatures

Patent Literature 1: Japanese Patent Application Publication No. Sho 56-68369
Patent Literature 2: Japanese Patent Application Publication No. Hei 08-154596
Patent Literature 3: Japanese Patent Application Publication No. Hei 09-163940
Patent Literature 4: Japanese Patent Application Publication No. Hei 09-154519

### Patent Literature 5: Japanese Patent Application Publication No. 2002-218947

### Patent Literature 6: Japanese Patent Application Publication No. 2014-23463

### SUMMARY OF INVENTION

### Problems to be Solved by the Invention

An object is to provide a dusting flour mix which can suppress generation of lumps without scattering of dusting flour when the dusting flour is coated on a cooking ingredient, and a method of producing the same.

### Means for Solution of the Problems

The present inventors and the like have made earnest studies to solve the problems above and found as a result that it is possible to eliminate scattering of dusting flour when the dusting flour is coated on a cooking ingredient and to suppress generation of lumps because the dusting flour does not become tacky even after moisture absorption by using a dusting flour mix comprising: 14 to 99.9% by mass of a pregelatinized starch and/or a pregelatinized cereal flour; and 0.1 to 86% by mass of an anti-scattering agent, wherein the anti-scattering agent includes wheat flour with a content of 0 to 86% by mass and/or an oil and/or fat with a content of 0 to 2.8% by mass relative to the dusting flour mix. This finding has led to the completion of the present invention.

Specifically, the present invention is as follows.

[1] A dusting flour mix comprising:

14 to 99.9% by mass of a pregelatinized starch and/or a pregelatinized cereal flour; and

0.1 to 86% by mass of an anti-scattering agent, wherein

the anti-scattering agent is composed of wheat flour, an oil and/or fat, or a mixture thereof,

a content A of the wheat flour is 0 to 86% by mass, and

a content B of the oil and/or fat is 0 to 2.8% by mass relative to the dusting flour mix.

[2] The dusting flour mix according to [1] described above, wherein

the anti-scattering agent is composed of the wheat flour, and

the content A of the wheat flour relative to the dusting flour mix is 14 to 86% by mass.

[3] The dusting flour mix according to [1] described above, wherein

the anti-scattering agent is composed of the oil and/or fat, and

the content B of the oil and/or fat relative to the dusting flour mix is 0.1 to 2.8% by mass.

[4] The dusting flour mix according to [1] described above, wherein

the anti-scattering agent is composed of the mixture of the wheat flour and the oil and/or fat,

the content A of the wheat flour is 14 to 86% by mass, and

the content B of the oil and/or fat is 0.1 to 2.8% by mass relative to the dusting flour mix.

### Advantageous Effects of Invention

The present invention makes it possible to provide a dusting flour mix which can suppress production of lumps without generating scattering of dusting flour when the dusting flour is coated on a cooking ingredient. It is possible to improve the workability of spreading the dusting flour and to provide a dusting flour with a reduced waste loss of the dusting flour.

### DESCRIPTION OF EMBODIMENTS

In the present invention, a dusting flour mix refers to a flour mixture used as a dusting flour. It is preferably a dusting flour mix used as a dusting flour coated on a cooking ingredient before cooking such as deep frying, grilling, and baking, and is further preferably a dusting flour mix used for deep-fried food. In the production of deep-fried food such as karaage, deep fries, tempura, and fritters, dusting flour is used for the purpose of preventing burning during deep frying and seepage of meat juices, umami taste ingredients, moisture, and the like by being coated on the cooking ingredient before the cooking ingredient is covered with a breader or batter, binding the cooking ingredient and the batter ingredient, and maintaining the crispy texture of the fried batter by preventing the migration of moisture in the cooking ingredient to the batter ingredient during preservation after deep frying. In addition, dusting flour is used for the purpose of suppressing the leakage of meat juices and the like when the cooking ingredient coated therewith is grilled or baked directly or with the addition of batter.

In the present invention, examples of the cooking ingredient include, but not limited to, marine products such as fish, shellfish, shrimps, and squids, livestock products such as beef, pork, lamb, and chicken, agricultural products such as potatoes, root crops, leaf vegetables, fruit vegetables, and mushrooms, and processed products thereof.

The dusting flour mix of the present invention is composed of 14 to 99.9% by mass of a pregelatinized starch and/or a pregelatinized cereal flour and 0.1 to 86% by mass of an anti-scattering agent.

The pregelatinized starch used in the present invention can be obtained by heating a hydrous raw starch with a drum dryer or the like for pregelatinization followed by pulverization by a known method, can be obtained by pregelatinization treatment with an extruder followed by pulverization by a known method, or can be obtained by another known method. Any raw starch can be suitably used as a raw material for the pregelatinized starch as long as it is an edible raw starch, and examples thereof can include wheat starch, corn starch, potato starch, tapioca starch, rice starch, sago starch, sweet potato starch, pea starch, and waxy starches thereof.

The pregelatinized cereal flour used in the present invention can be obtained by treating cereal pulverized products not containing crusts or embryos, which are obtained by pulverization in accordance with a known method, as in the case of the pregelatinized starch described above.

The content of the pregelatinized starch and/or pregelatinized cereal flour relative to the dusting flour is 14 to 99.9% by mass, preferably 30 to 99.5% by mass, and more preferably 50 to 99% by mass relative to the total amount of the dusting flour mix. Lumps are likely to generate when the content is less than 14% by mass, and scattering increases when the content exceeds 99.9% by mass.

In the present invention, the anti-scattering agent is wheat flour with a content of 0 to 86% by mass and/or an oil and/or fat with a content of 0 to 2.8% by mass relative to the dusting flour mix.

In the present invention, wheat flour can be suitably used as long as it is a wheat grain pulverized product not containing crusts or embryos, which is obtained by pulverizing wheat grains in accordance with a known method, and examples thereof include weak flour, medium flour, and strong flour.

Any wheat grains can be used as long as they are wheat grains harvested from ordinary wheats such as bread wheat, spelt wheat, and club wheat and two-grain wheats such as durum wheat or emmer wheat. Weak flour is preferable, which can be obtained by pulverizing bread wheat grains.

In the present invention, any oil and/or fat can be suitably used as long as it is an edible oil and/or fat. Examples of such an oil and/or fat can include oils which are liquid at room temperature such as salad oil, corn oil, soybean oil, sesame oil, rapeseed oil, safflower oil, olive oil, linseed oil, and fish oil, cream-like hardened oils (shortening and the like) or solid-like hardened oils (margarine and the like) obtained by hydrogenating these liquid oils, and fats which are solid at room temperature such as cacao butter, peanut butter, palm fat, beef tallow, lard, chicken fat, and milk fat. Liquid oils and cream-like hardened oils having fluidity can directly be mixed in pregelatinized starch and/or pregelatinized cereal flour. Solid hardened oils and solid fats can be heated to liquid form followed by mixing in pregelatinized starch and/or pregelatinized cereal flour or can be mixed in pregelatinized starch and/or pregelatinized cereal flour and heated to a temperature equal to or higher than the melting point followed by further mixing.

The content of the anti-scattering agent relative to the dusting flour is 0.1 to 86% by mass, preferably 0.5 to 70% by mass, and more preferably 1 to 50% by mass relative to the total amount of the dusting flour mix. In addition, the content A of the wheat flour relative to the dusting flour mix is 0 to 86% by mass, and the content B of the oil and/or fat relative to the dusting flour mix is 0 to 2.8% by mass.

In the case of singly using wheat flour as an anti-scattering agent, the content A of the wheat flour relative to the dusting flour mix is preferably 14 to 86% by mass and more preferably 30 to 70% by mass. Scattering increases when the content is less than 14% by mass, and lumps are likely to generate when the content exceeds 86% by mass.

In the case of singly using an oil and/or fat as an anti-scattering agent, the content B of the oil and/or fat relative to the dusting flour is preferably 0.1 to 2.8% by mass and more preferably 1.0 to 2.5% by mass. Scattering increases when the content is less than 0.1% by mass, and the dusting flour is sticky due to the oil and/or fat when the content exceeds 2.8% by mass, making it likely to generate “lumps composed of the oil and/or fat and the dusting flour.”

When wheat flour and an oil and/or fat are used in combination as an anti-scattering agent, it is possible to obtain a better scattering-preventing effect than the case of singly using wheat flour or oil and/or fat.

In the case of using wheat flour and an oil and/or fat in combination as an anti-scattering agent, it is preferable that the content A of the wheat flour be 14 to 86% by mass and the content B of the oil and/or fat be 0.1 to 2.8% by mass relative to the dusting flour mix. It is further preferable that the content A of the wheat flour be 30 to 70% by mass and the content B of the oil and/or fat be 1.0 to 2.5% by mass relative to the dusting flour mix.

In addition, the content A of the wheat flour and the content B of the oil and/or fat relative to the dusting flour mix fall below the respective lower limits preferable in the case of single use (A=14% by mass and B=0.1% by mass), it is preferable to satisfy A/14+B/0.1>1.

The dusting flour mix of the present invention can be produced by thoroughly mixing pregelatinized starch and/or pregelatinized cereal flour as a raw material, wheat flour, an oil and/or fat, or a mixture thereof as an anti-scattering agent. The means of mixing is not particularly limited. In the case of mixing powder form raw materials, for example, production is possible by charging powder form raw materials in the drum of a powder mixer followed by shake rotation. In addition, in the case where a powder form raw material and a liquid form raw material are contained, for example, production is possible if the powder form raw material is charged into the drum of a liquid addition type powder mixer followed by shake rotation for sufficient mixing and then the liquid form raw material is added little by little followed by shake rotation for sufficient mixing.

### EXAMPLES

Hereinafter, examples are provided in order to specifically describe the present invention, but the present invention is not limited only to the following examples.

### Production Example 1 Dusting Flour Mix Composed of Pregelatinized Starch and Oil and/or Fat

(1) Into the drum of a liquid addition type powder mixer with a disintegrating function, 98.5 parts by mass of pregelatinized starch (GWS 1600CG manufactured by MGP Ingredients Inc., pregelatinized wheat starch) was charged.
(2) While shaking and rotating the drum under the condition of 60 rpm, 1.5 parts by mass of an oil and/or fat (salad oil manufactured by Nisshin Oillio, Ltd.) was gradually added through the injection nozzle.
(3) The oil and/or fat was completely added, followed by further shake rotation for 5 minutes at 60 rpm for sufficient mixing.

### Production Example 2 Dusting Flour Mix Composed of Pregelatinized Starch and Wheat Flour

(1) Into the drum of a powder mixer, 50 parts by mass of pregelatinized starch (GWS 1600CG manufactured by MGP Ingredients Inc.) and 50 parts by mass of wheat flour (Dia manufactured by Nippon Flour Mills Co., Ltd.) were charged.
(2) The mixture was shaken and rotated for 5 minutes at 60 rpm for sufficient mixing.

### Production Example 3 Dusting Flour Mix Composed of Pregelatinized Starch, Oil and/or Fat, and Wheat Flour

(1) Into the drum of a liquid addition type powder mixer with a disintegrating function, 50 parts by mass of pregelatinized starch (GWS 1600CG manufactured by MGP Ingredients Inc.) and 48.5 parts by mass of wheat flour (Dia manufactured by Nippon Flour Mills Co., Ltd.) were charged.
(2) While shaking and rotating the drum, 1.5 parts by mass of an oil and/or fat (salad oil manufactured by Nisshin Oillio, Ltd.) was gradually added through the injection nozzle.
(3) The oil and/or fat was completely added, followed by further shake rotation for 5 minutes at 60 rpm for sufficient mixing.

### Test Example 1 Powdering of Dusting Flour Mix (Pregelatinized Starch+Oil and/or Fat) on Cooking Ingredient

(1) The dusting flour mix was obtained in accordance with Production Example 1 except that the amounts of pregelatinized starch and oil and/or fat were as described in Table 2.
(2) Into a powdering machine (Powder Machine Model PDM manufactured by Asahi Sosetsu Co., Ltd.), 20 kg of the obtained dusting flour mix was charged.
(3) On the conveyer of the powdering machine, 100 pieces of white-flesh fish (1.5×4.0×6.0 cm, 35 g/l piece) were placed, followed by powdering of the dusting flour mix on the white-flesh fish.
(4) Ten expert panelists carried out a suitability evaluation as dusting flour on the scattering during powdering process, generation of lumps after powdering process, and adhesiveness of the dusting flour to the white-flesh fish in accordance with the criteria of Table 1. Note that the acceptable dusting flours satisfied score 3 or higher for each of the generation of lumps, workability, and scattering.

### (Evaluation Criteria Table)

TABLE 1

| | | |
|---|---|---|
| Scattering | Score 5 | No degree of scattering |
| | Score 4 | Almost no degree of scattering |
| | Score 3 | Scattering to some degree |
| | Score 2 | Scattering to a large degree |
| | Score 1 | Scattering to a very large degree |
| Generation | Score 5 | No lumps produced, very good |
| of Lumps | Score 4 | Almost no lumps produced, good |
| | Score 3 | Small number of lumps produced, acceptable |
| | Score 2 | Large number of lumps produced, bad |
| | Score 1 | Very large number of lumps produced, very |
| | | bad |
| Adhesiveness | Score 5 | Coated uniformly, very good |
| to Cooking | Score 4 | Coated almost uniformly, good |
| Ingredient | Score 3 | Coated without unevenness, acceptable |
| | Score 2 | Coated with some unevenness, bad |
| | Score 1 | Coated with conspicuous unevenness, very |
| | | bad |

TABLE 2

| | | | | | Comparative | | Target |
|---|---|---|---|---|---|---|---|
| | Example | | | | Example | | Example |
| | 1 | 2 | 3 | 4 | 1 | 2 | 1 |
| Pregelatinized | 97.2 | 97.5 | 98.5 | 99.85 | 97 | 99.95 | 100 |
| Wheat Starch | | | | | | | |
| (Parts by Mass) | | | | | | | |
| Oil and/or Fat | 2.8 | 2.5 | 1.5 | 0.15 | 3 | 0.05 | 0 |
| (Parts by Mass) | | | | | | | |
| Scattering | 4.9 | 4.5 | 4.1 | 3.6 | — | 2.4 | 1.5 |
| Lump Generation | 3.6 | 4.3 | 4.8 | 4.8 | — | 4.9 | 4.9 |
| Adhesiveness | 4.2 | 4.3 | 4.6 | 4.7 | — | 4.8 | 4.8 |

When the pregelatinized starch was blended with an oil and/or fat, scattering was suppressed depending on the increase in the amount blended. However, in Comparative Example 1 blended with 3% by mass of oil and/or fat, the pregelatinized starch was tacky due to the oil and/or fat, generating “lumps composed of the oil and/or fat and the dusting flour,” which was unsuitable as a dusting flour and was not used for powdering. In Comparative Example 2 and Target Example 1, the generation of lumps and the adhesiveness of the dusting flour to the white-flesh fish were very good, but the scattering was intense and the workability was bad.

### Test Example 2 Powdering of Dusting Flour Mix (Pregelatinized Starch+Wheat Flour) on Cooking Ingredient

The dusting flour mix was obtained in accordance with Production Example 2 except that the amounts of pregelatinized starch and wheat flour were as described in Table 3, and a suitability evaluation was carried out on what was used for powdering on the white-flesh fish as in the case of Test Example 1.

TABLE 3

| | | | | Comparative | | Target | |
|---|---|---|---|---|---|---|---|
| | Example | | | Example | | Example | |
| | 5 | 6 | 7 | 3 | 4 | 2 | 3 |
| Pregelatinized | 15 | 50 | 85 | 10 | 90 | 100 | 0 |
| Wheat Starch | | | | | | | |
| (Parts by Mass) | | | | | | | |
| Wheat Flour | 85 | 50 | 15 | 90 | 10 | 0 | 100 |
| (Parts by Mass) | | | | | | | |
| Scattering | 4.0 | 3.8 | 3.3 | 4.3 | 2.4 | 1.5 | 4.7 |
| Lump Generation | 3.1 | 3.6 | 4.0 | 2.1 | 4.8 | 4.9 | 1.4 |
| Adhesiveness | 3.2 | 3.5 | 3.7 | 2.7 | 4.2 | 4.8 | 1.8 |

When the pregelatinized starch was blended with wheat, scattering was suppressed depending on the increase in the amount blended. However, when the wheat flour was 90% by mass or more, the moisture of the cooking ingredient seeped to the wheat flour, making it likely for lumps to produce, which led to bad results of both the lump generation and adhesiveness as well as decrease in workability.

### Test Example 3 Powdering of Dusting Flour Mix (Pregelatinized Starch+Oil and/or Fat+Wheat Flour) on Cooking Ingredient

The dusting flour mix was obtained in accordance with Production Example 3 except that the amounts of pregelatinized starch, oil and/or fat, and wheat flour were as described in Table 4, and a suitability evaluation was carried out on what was used for powdering on the white-flesh fish as in the case of Test Example 1.

TABLE 4

| | Example | | | | | |
|---|---|---|---|---|---|---|
| | 8 | 9 | 10 | 11 | 12 | 13 |
| Pregelatinized | 15 | 30 | 50 | 70 | 85 | 15 |
| Wheat Starch | | | | | | |
| (Parts by Mass) | | | | | | |
| Oil and/or Fat | 0.1 | 0.5 | 1.5 | 2.0 | 2.0 | 2.8 |
| (Parts by Mass) | | | | | | |
| Wheat Flour | 84.9 | 69.5 | 48.5 | 28 | 13 | 82.2 |
| (Parts by Mass) | | | | | | |
| Scattering | 4.2 | 4.8 | 4.4 | 4.8 | 4.6 | 4.9 |
| Lump Generation | 3.1 | 3.4 | 4.2 | 4.3 | 4.5 | 3.1 |
| Adhesiveness | 3.2 | 3.5 | 4.0 | 4.3 | 4.5 | 3.1 |

It was found that the effective suppression of scattering of the pregelatinized starch was possible by using an oil and/or fat and wheat flour in combination as an anti-scattering agent.

### Test Example 4 Consideration of Pregelatinized Starch Used in Dusting Flour Mix

The dusting flour mix was obtained in accordance with Production Example 1 (pregelatinized starch:oil and/or fat=98.5:1.5) except that the pregelatinized starches described in Table 5 were used, and a suitability evaluation was carried out on what was used for powdering on the white-flesh fish as in the case of Test Example 1.

Note that the pregelatinized corn starch used was Corn Alpha Y manufactured by Sanwa Starch Co., Ltd., the pregelatinized tapioca starch used was Amycol KF manufactured by Nippon Starch Chemical Co., Ltd., and the pregelatinized potato starch used was Amycol HF manufactured by Nippon Starch Chemical Co., Ltd.

TABLE 5

Example

| | 3 | 14 | 15 | 16 |
|---|---|---|---|---|
| Pregelatinized | Wheat | Corn | Tapioca | Potato |
| Starch | | | | |
| Scattering | 4.1 | 4.0 | 4.3 | 4.1 |
| Lump Generation | 4.8 | 3.9 | 4.2 | 4.5 |
| Adhesiveness | 4.5 | 4.0 | 4.0 | 4.2 |

### Test Example 5 Consideration of Pregelatinized Cereal Flour Used in Dusting Flour Mix

The dusting flour mix was obtained in accordance with Production Example 2 (pregelatinized cereal flour:wheat flour=50:50) except that the non-pregelatinized cereal flours and the pregelatinized cereal flours instead of the pregelatinized starch described in Table 6 were used, and a suitability evaluation was carried out on what was used for powdering on the white-flesh fish as in the case of Test Example 1.

Note that the pregelatinized wheat flour used was Pregelatinized Wheat Flour F100 manufactured by Frystar Co., Ltd., the pregelatinized rice flour used was Rice Star H2D manufactured by Matsutani Chemical Industry Co., Ltd., and the pregelatinized corn flour used was a Corn T manufactured by Nippon Flour Mills Co., Ltd. Regarding the non-pregelatinized cereal flours of the comparative examples, the rice flour used was Kosa 115 manufactured by Mizuho Shokuhin, and the corn flour used was F Corn Flour manufactured by Nippon Flour Mills Co., Ltd.

TABLE 6

| | | | | Comparative | |
|---|---|---|---|---|---|
| | Example | | | Example | |
| | 17 | 18 | 19 | 5 | 6 |
| Flour | Pregela- | Pregela- | Pregela- | Rice Flour | Corn |
| | tinized | tinized | tinized | | |
| | Wheat Flour | Rice Flour | Corn | | |
| Scattering | 4.2 | 4.0 | 4.4 | 4.0 | 4.5 |
| Lump | 3.8 | 4.1 | 4.2 | 2.1 | 2.0 |
| Generation | | | | | |
| Adhesiveness | 3.5 | 3.7 | 3.7 | 2.4 | 2.2 |

It was possible to obtain a good dusting flour mix by blending wheat flour even when any of the pregelatinized cereal flours was used.

### Test Example 6 Production of White-Flesh Fish Deep Fry

White-flesh fish coated with the dusting flours of Examples 3, 7, 12, 14, and 18 was covered with batter liquid formed by dissolving 100 parts by weight of batter mix (B2680 manufactured by Nippon Flour Mills Co., Ltd.) into 350 parts by weight of water and coated evenly with raw bread crumbs (NF Color Raw Bread Crumbs manufactured by Fuji Panko Kogyo Co., Ltd.) to obtain white-flesh fish with bread crumbs for frying in oil. This was deep fried in salad oil heated to 180° C. to produce a white-flesh fish deep fry.

When the white-flesh fish deep fry was tasted immediately after the deep frying and 1 hour after the deep frying, there was no batter separation in both cases, and the juicy feeling of the white-flesh fish and the crispy texture of the fried batter were both good.

### Test Example 7 Production of Frozen White-Flesh Fish Deep Fry

A white-flesh fish deep fry was produced in accordance with Test Example 6 except that the white-flesh fish with bread crumbs for frying in oil was rapidly frozen and stored at −20° C. for 1 week, followed by deep frying without thawing in salad oil at 180° C.

When the white-flesh fish deep fry was tasted immediately after the deep frying and 1 hour after the deep frying, there was no batter separation in both cases, and the texture was good.

### Test Example 8 Production of Deep Fried Food of Various Cooking Ingredients

Cooking ingredients coated with dusting flour were obtained in accordance with Example 12 except that pork loin meat, raw squid, sweet potato, and korokke paste prepared to the same size as the white-flesh fish were used, and deep-fried foods were obtained in accordance with Test Example 6.

When the deep-fried foods were tasted immediately after the deep frying and 1 hour after the deep frying, none of them had batter separation, and the texture was good.

What is claimed is:

1. A dusting flour mix comprising:
14 to 99.9% by mass of a pregelatinized starch and/or a pregelatinized cereal flour; and
0.1 to 86% by mass of an anti-scattering agent, wherein
the anti-scattering agent is composed of wheat flour, an oil and/or fat, or a mixture thereof,
a content A of the wheat flour is 0 to 86% by mass, and
a content B of the oil and/or fat is 0 to 2.8% by mass relative to the dusting flour mix.

2. The dusting flour mix according to claim 1, wherein
the anti-scattering agent is composed of the wheat flour, and
the content A of the wheat flour relative to the dusting flour mix is 14 to 86% by mass.

3. The dusting flour mix according to claim 1, wherein
the anti-scattering agent is composed of the oil and/or fat, and
the content B of the oil and/or fat relative to the dusting flour mix is 0.1 to 2.8% by mass.

4. The dusting flour mix according to claim 1, wherein
the anti-scattering agent is composed of the mixture of the wheat flour and the oil and/or fat,
the content A of the wheat flour is 14 to 86% by mass, and
the content B of the oil and/or fat is 0.1 to 2.8% by mass relative to the dusting flour mix.
